(19) United States
(12) Patent Application Publication
(10) Pub. No.: US 2009/0206521 A1
(43) Pub. Date: Aug. 20, 2009

(54) METHOD OF MANUFACTURING LINER FOR SEMICONDUCTOR PROCESSING CHAMBER, LINER AND CHAMBER INCLUDING THE LINER

(76) Inventor: Bakir Begovic, Menlo Park, CA (US)

Correspondence Address: NIXON PEABODY, LLP, 401 9TH STREET, NW, SUITE 900, WASHINGTON, DC, 20004-2128, US

(21) Appl. No.: 12/031,636

(22) Filed: Feb. 14, 2008

(51) Int. Cl. B29C 71/00; B29C 59/02; B05C 11/00

(52) U.S. Cl. 264/442; 264/39; 118/715; 264/293

(57) ABSTRACT

A method for manufacturing a liner for a process chamber, a liner and a process chamber including the liner. A surface of a liner material is impressed with impressions by pressing, punching, dimpling, embossing, drilling, knurling or otherwise mechanically altering the surface without removing material. The impressions include depressions, protuberances, or a combination of depressions and protuberances that are separate or merge together. The impressions may be formed as one group or as two consecutive groups and may have different shapes and arrangement patterns. The surface may be roughened before or after forming the impressions. The roughening may be obtained from particulate blasting, plasma spray, and arc spray. The sheet of material may be aluminum, steel, an alloy or a composite material that is capable of being impressed by pressing or punching. The liner may be disposable or may be cleaned after a certain number of usage cycles.

### BACKGROUND OF THE INVENTION

1. Field of the Invention

This invention relates to chambers for processing semiconductors and, more particularly, to liners used in semiconductor process chambers.

2. Description of the Related Art

Semiconductor processing, for example processing of semiconductor wafers to form integrated circuits (IC), is usually performed in several stages. Some stages and types of semiconductor processing are performed in semiconductor processing chambers. These types of processing may include physical vapor deposition (PVD), chemical vapor deposition (CVD), plasma etch processes, ion metal plasma (IMP), atomic layer deposition (ALD), ion implantation, annealing and the like. In most of these processes, a substrate is exposed to one or more gas-phase materials. For example, in the PVD and CVD processes, atoms of a target material are deposited on a substrate such as a semiconductor wafer. In plasma etching the wafer is etched away by being bombarded by the plasma.

Whether, the semiconductor processing is intended to deposit material on a substrate or it is intended to etch material away from the substrate, there will be some portion of this material that is free to move within the chamber and has the potential of being deposited on the walls of the chamber. Other process related material may also be present in the chamber and deposit on the walls, ceilings and other unintended surfaces of the chamber. For example, polymers used in etch, the chemicals being carried in the plasma in CVD or the material sputtered away from a target in PVD or plasma etch processes may deposit anywhere within the chamber. If they are deposited other than on the intended substrate or wafer, the deposited material have the potential of peeling off and landing on the wafer as contamination or re-entering the process gases as contamination. They also have the potential of reappearing in the plasma as undesired components.

Accordingly, there is a need for reducing the potential for contamination of the chamber and the wafer by the material deposited on the internal walls of the processing chamber. One method of addressing this need is using liners inside the process chambers that line the walls of the chamber. The contaminants adhere to the liners. Once the capacity and capability of a liner for adhering to the contaminants is reduced, the liners may be removed and cleaned or disposed and replaced with new liners.

FIG. 1A shows a perspective view of a workpiece 100 that may be used as a part of a process chamber for reducing contamination in the process chamber. This workpiece may be considered a first conventional liner. FIG. 1B is a plan view of the workpiece 100 of FIG. 1A. FIG. 1C is a cross sectional view of one depression 110 of FIGS. 1A and 1B.

The workpiece 100 of FIGS. 1A and 1B includes the depressions 110 that are formed with a circular cross-section in plan view. The depressions 110 may be associated with protuberances 111 on all sides. A conventional method of forming the depressions and protuberances of the workpieces 100 is by scanning a beam of electromagnetic energy across the surface of the workpiece. In this conventional method, the workpiece material may be a metal, a metal alloy, a ceramic material, a polymer material, or a composite material. Examples of these materials include steel, tantalum, tungsten, titanium, aluminum, aluminum oxide, silicon oxide or quartz.

The material on the surface and interior of the workpiece is heated to a high temperature by the electromagnetic beam. The high temperature may be above the boiling temperature of the material forming the workpiece 100. The rapid heating of portions of the workpiece causes the material to be ejected outwards. This forms depressions 110 in a location from which the material has been ejected and also may form the protuberances 111 in locations to which the ejected material has deposited.

FIG. 2A is a plan view of a second conventional liner 200 having protrusions 210 of rectangular cross-section. FIG. 2B is a cross-sectional view of the conventional liner 200 of FIG. 2A showing the protrusions 210 having rectangular cross-sections also in the direction perpendicular to the plan view. The liner 200 has a texture consisting of a two-dimensional array of square protrusions 210 having walls 211 protruding from the surface of the liner 200.

FIG. 3 is a cross-sectional view of a third conventional liner 300 showing depressions 310 having oblique angles in the direction perpendicular to the plan view. The topographical features in the liner 300 are depressions into the surface of the liner 300 rather than protrusions above the surface. The sides of the depressions 310 are formed at an oblique angle relative to a plane of the liner. The liner portions between the depressions 310 are shown as walls 311.

FIG. 4A is a plan view of a fourth conventional liner 400 having depressions 410 of circular cross-section. FIG. 4B is a cross-sectional view of the liner 400 of FIG. 4A showing a semi-circular cross-section for the depressions 410 in the direction perpendicular to the plan view. Walls 411 remain between the depressions 410. The depressions 410 may be drilled into the liner 400.

FIG. 5A is a perspective view of a fifth conventional liner 500 that is cylindrical to fit the internal walls of a process chamber. The texture used in the cylindrical side wall liner 500 consists of a series of circumferential grooves 510. FIG. 5B shows a cross-section of the liner 500. The grooves 510 are separated by walls 511. The circumferential grooves are machined into an aluminum sheet and the aluminum is subsequently anodized using lathe. The process of machining involves removing material.

FIG. 6 shows a perspective view of a sixth conventional liner 600 that has a waffle format including both circumferential and longitudinal grooves. The waffle format of the liner 600 is obtained when both circumferential and longitudinal grooves are formed in the sheet of aluminum.

Further information about conventional liners may be found in U.S. Pat. No. 6,933,508 and U.S. Pat. No. 6,812,471 to Paliolkowski and U.S. Pat. No. 6,797,639 to Carducci.

### SUMMARY OF THE INVENTION

According to aspects of the invention, a method for manufacturing a liner for a process chamber, a liner and a process chamber including the liner are provided. A surface of a liner material is impressed with impressions by pressing, punching, dimpling, embossing, drilling, knurling or otherwise mechanically altering the surface without removing material. The impressions include depressions, protuberances, or a combination of depressions and protuberances that are separate or merge together. The impressions may be formed as one group or as two consecutive groups and may have different shapes and arrangement patterns. The surface may be roughened before or after forming the impressions. The roughening may be obtained from particulate blasting, plasma spray, and arc spray. The sheet of material may be aluminum, steel, an alloy or a composite material that is capable of being impressed by pressing or punching. The liner may be disposable or may be cleaned after a certain number of usage cycles.

According to aspects of the invention, a method for manufacturing a liner for a process chamber is provided, the method comprising: impressing a surface of a sheet of material with impressions; and cleaning the sheet of material; wherein the impressing comprises mechanically altering the surface without removing material. The method may further comprise roughening the surface prior to the cleaning. The roughening may be selected from a group consisting of particulate blasting, plasma spray, and arc spray. The cleaning may comprise washing the sheet of material with de-ionized water and applying ultrasonic energy. The impressing may be selected from a group consisting of pressing, punching, dimpling, knurling, or embossing the first surface. The method may further comprise drilling holes in the surface. The method may further comprise forming the sheet of material to conform to the process chamber after the roughening. The method may further comprise forming the sheet of material to conform to the process chamber before the impressing. The impressing may comprise rotating the formed sheet of material and pressing against the surface with a knurling drum. The pressing against the surface with a knurling drum may comprise rotating the knurling drum against the surface.

According to aspects of the invention, a liner for use in process chambers is provided, the liner comprising: a sheet of material having a surface being exposed to gases in the process chamber, wherein the surface comprises impressions being formed mechanically and without removing material from the first surface. The impressions may be selected from a group consisting of depressions, protuberances, or a combination of depressions and protuberances. The impressions may have a cross-section in plan view selected from the group consisting of circular, rectangular, star-shaped, parallel grooves and crisscrossed grooves. The impressions may have a shape in a direction perpendicular to the plan view selected from the group consisting of rectangular with straight walls, rectangular with tapered walls, hemispherical, pyramid-shaped, cylindrical, and hole-shaped with protuberances protruding from the first surface around the hole-shaped impression. The impressions may be formed in a pattern selected from the group consisting of matrix pattern, staggered superimposed matrices pattern, circular pattern, and helical pattern.

According to aspects of the invention, a method for manufacturing a liner for a process chamber is provided, the method comprising: forming a liner having an interior surface; impressing the interior surface with a plurality of impressions; wherein the impressing comprises mechanically altering the interior surface without removing material from the interior surface. The method may further comprise impressing the interior surface with second set of plurality of impressions. The plurality of impressions may comprise a first matrix of depressions, the second set of plurality of impressions comprises a second matrix of depressions, and each depression of the second matrix of depressions is formed between respective depressions of the first matrix of depressions. The method may further comprise spraying particles on the interior surface to introduce roughness; and, cleaning the sheet of material. The impressing may be selected from a group consisting of pressing, punching, dimpling, knurling, or embossing the first surface.

### BRIEF DESCRIPTION OF THE DRAWINGS

The accompanying drawings, which are incorporated in and constitute a part of this specification exemplify the embodiments of the present invention and, together with the description, serve to explain and illustrate principles of the inventive technique. Specifically:

FIG. 1A is a perspective view of a first conventional liner forming an internal surface of a process chamber.

FIG. 1B is a plan view of the liner of FIG. 1A.

FIG. 1C is a cross sectional view of one depression of FIGS. 1A and 1B.

FIG. 2A is a plan view of a conventional ceiling liner having protrusions of rectangular cross-section.

FIG. 2B is a cross-sectional view of the conventional liner of FIG. 2A showing the protrusions having rectangular cross-sections also in the direction perpendicular to the plan view.

FIG. 3 is a cross-sectional view of a third conventional liner showing depressions having oblique angles in the direction perpendicular to the plan view.

FIG. 4A is a plan view of a fourth conventional liner having depressions of circular cross-section.

FIG. 4B is a cross-sectional view of the liner of FIG. 4A showing a semi-circular cross-section for the depressions in the direction perpendicular to the plan view.

FIG. 5A is a perspective view of a fifth conventional liner showing a texture consisting of a series of circumferential grooves in a cylindrical side wall liner.

FIG. 5B is a cross-sectional view of the liner of FIG. 5A.

FIG. 6 is a perspective view of a sixth conventional liner having both circumferential and longitudinal grooves.

FIG. 7 is a flow chart of a process for manufacturing a liner according to one aspect of the invention.

FIGS. 8A, 8B, 8C and 8D show perspective views of a liner being manufactured according to the process of FIG. 7.

FIG. 8E shows a side view of a liner being manufactured according a variation of the process of FIG. 7

FIG. 9 is a flow chart of a process for manufacturing a liner according to another aspect of the invention.

FIGS. 10A, 10B, 10C, 10D and 10E show perspective views of a liner being manufactured according to the process of FIG. 9.

FIGS. 11A, 11B and 11C show plan views of a liner according to one aspect of the invention showing formation of the liner according to the process of FIG. 7 or 9. FIGS. 11D and 11E show cross-sectional views of the liner of FIG. 11C along two different cross-sections.

FIGS. 12A and 12B show plan views of a liner according to another aspect of the invention.

FIGS. 13A and 13B show plan views of a liner according to yet another aspect of the invention.

FIGS. 14A and 14B show plan views of a liner according to a further aspect of the invention.

FIGS. 15A and 15B show plan views of a liner according to yet a further aspect of the invention.

FIG. 16 shows several exemplary patterns of formation of the holes or impressions in plan view.

FIG. 17 shows several exemplary cross-sectional views of the holes or impressions in a direction perpendicular to the plan view.

FIG. 18 is a processing chamber including a liner according to one of the aspects of the invention.

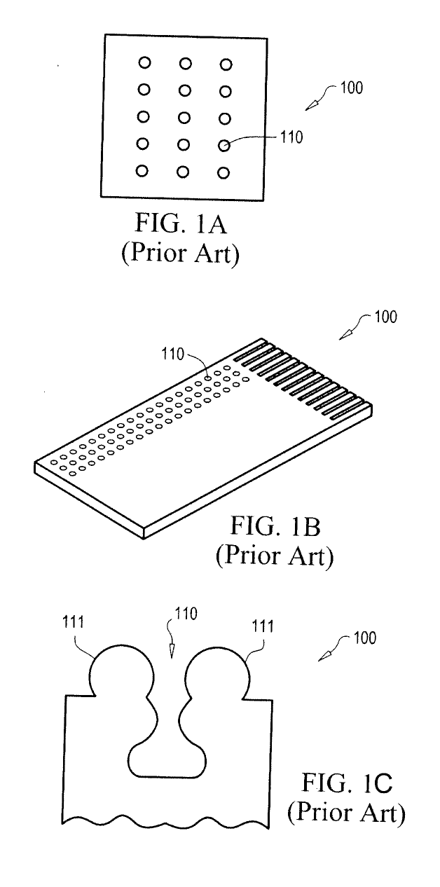

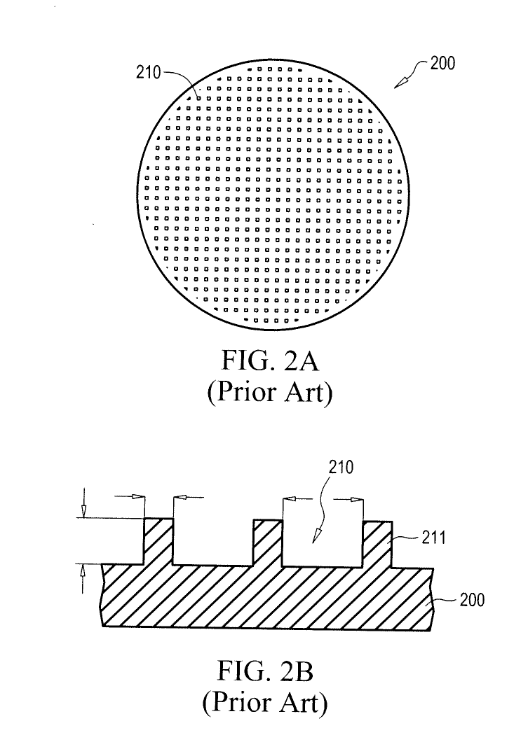

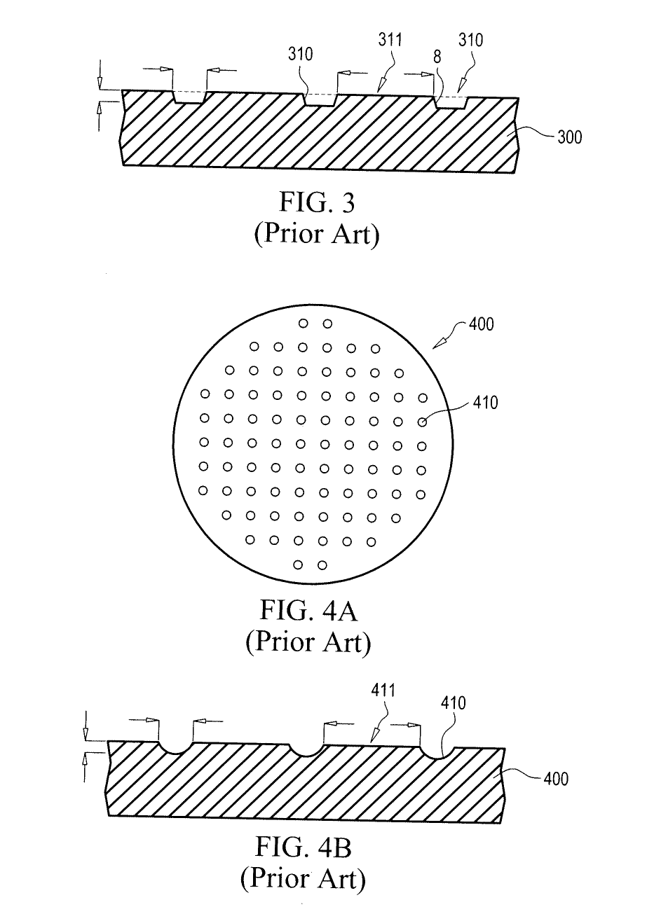

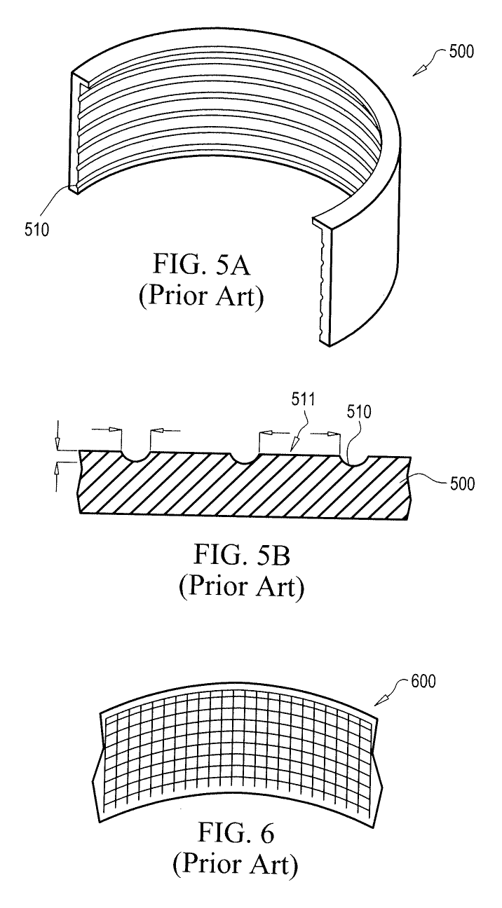

### DETAILED DESCRIPTION

The potential for contamination of chamber by material deposited on the walls of the chamber may be reduced by improving the adhesion between the walls and the material within the processing chamber that are deposited on the walls. This material may be atoms being carried by the plasma, process gases, polymers, or particulates floating within the chamber.

Alternatively, a liner may be added to line the internal walls of the processing chamber. Then, this liner may be manufactured to have improved adhesion with the material in the plasma within the plasma chamber. A liner may alternatively be called a shield. A shield is said to shield the walls of the process chamber.

When the thickness of the layer of contamination increases beyond a limit, the adhesivity between the liner material and the contamination layer is no longer sufficient to hold the contamination attached to the liner. Thermal cycling occurring in the chamber causes flaking of the material adhering to the chamber walls or the liner. When the adhesivity between the contamination layer and the liner is reduced, thermal cycling may cause the contamination to flake off and fall onto the substrate or return to the plasma as a contaminant and the liner or the shield is no longer effective.

The liner or shield may be recyclable. In that case, the liner or shield is cleaned after a certain period of time or after a certain number of processing cycles. The liner or shield is generally removed from the chamber before being cleaned.

The liner or shield may be disposable. Disposable liners and shields are discarded after they collect a certain amount of contaminants. For example, when the thickness of the layer of the contamination collected on the liner or shield is such that the layer is prone to flaking and falling off, the liner or shield is removed from the chamber and replaced with a fresh liner or shield.

Adhesion of deposited films to a liner may be improved by introducing surface topography to the liner or texturing the liner. A textured surface has more surface area for the material to bond to. Further, elevations perpendicular to a surface of the liner may help reduce cracking of the deposited film due to thermal expansion and contraction. The elevation or height of the surface topography would make it more difficult to clean the liner if the liner is of the recyclable type. If the liner is of the disposable type, an excessive height may make the liner susceptible to accidental damage by decreasing its strength.

Features and aspects of the present invention provide a method of manufacturing a liner, a liner for use within a semiconductor processing chamber, and a semiconductor processing chamber including the liner.

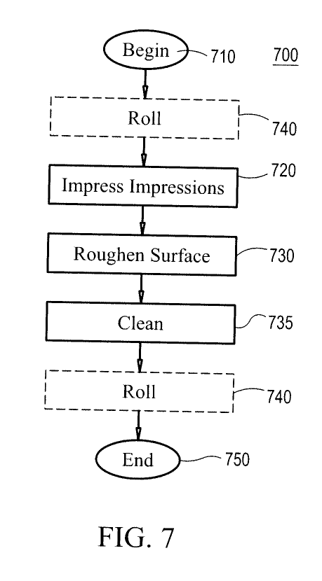

FIG. 7 is a flow chart of a process 700 for manufacturing a liner according to one aspect of the invention.

The process 700 of FIG. 7 begins in 710. First, impressions are impressed 720 in a liner material. Next, the process proceeds to roughening 730 of a surface of the liner material. After roughening the surface 730, the liner material may be rolled 740 into a form to fit an interior of the process chamber. The process then ends 750. Alternatively, the roughening of the surface may be conducted before impressing the surface of the liner with impressions. In some embodiments, a cleaning step 735 may follow the formation of the impressions and the roughening of the surface.

In a variation of the process 700 of FIG. 7, the rolling 740 may be performed before any further processing and the rolled material may be impressed after it has been rolled.

First a liner material is selected and the impressions are impressed 720 onto the surface of the liner. Forming of the impressions is performed mechanically and without removing any material from the liner. Impressing impressions onto the surface of the liner may include forming of the depressions and protuberances or a combination of the two. The impressions may be formed on the surface of the liner by mechanically compressing the liner material. For example, the surface of the liner material may be mechanically punched or pressed. This increases the strength of the material in the vicinity of the punch by introducing defect induced stress. The increase in the strength of the material is similar to that induced by cold rolling. Punching is performed such that it does not go all the way through the liner and dimples the surface of the liner. A variety of methods such as stamping, pressing, or embossing may be used to impress and form the impressions or depressions. The impressions may be formed by machining or by using a CNC device. The impressions may be drilled into the liner material. Other types of mechanical methods of forming the impressions may be used. Alternatively, chemical methods such as etch may be used for forming the impressions.

When the liner material is first rolled before the impressions are impressed, a knurling drum may be used to create a knurling, criss-crossed, or any other pattern onto the surface of the liner.

All of the impressions may be formed together. Alternatively, a first set of impressions may be formed first and subsequent sets of impressions may be formed subsequently. The subsequent sets of impressions may be formed in between the earlier formed impressions or in different areas of the liner surface.

The impressions may be formed with various patterns. They may be formed along straight parallel lines or along curved paths such as a helical path. The features formed on the liner may contact or overlap or merge.

The impressions may be formed with a variety of shapes in the plan view. They may be, for example, circular, elliptical, triangular, star-shaped, or circular with center spot.

The impressions may be formed with various cross-sectional shapes. For example, they may have straight or tapered walls. For example, the impressions may have a hemispherical shape, the shape of an inverted pyramid, or a cylindrical shape. A combination of depressions and protuberances may be used. For example, the impressions may appear as holes surrounded by hills, formed by the material pushed out of the hole, in the cross-section.

The roughening or texturizing 730 may be performed by blasting the surface of the liner material with particulates. Different types of grid blasting may be used to roughen the surface of the liner. Bead blasting and sand blasting, using silicon or glass beads are examples of roughening methods by grid blasting. In bead blasting particles of aluminum oxide or silicon dioxide are sprayed at the surface of the liner material. The roughening or texturizing of the surface may also be achieved by applying a coating such as a thin coating of aluminum deposited by an aluminum arc spray to the surface. Plasma spray may also be used for roughening. Plasma may be used for material treatment, such as annealing process, for etching, e.g., as a cleaning process, or for depositing material. The roughening texturizes the surface of the liner material and a texturized surface may have enhanced adhesion to the condensed material depositing on the liner.

The roughening or texturizing process 730 may be used to introduce impressions, depressions and protuberances that have smaller dimensions than those introduced during the impressing of the impressions 720.

In an alternative aspect of the invention, the roughening of the surface may take place before the impressions have been formed.

In yet another alternative aspect of the invention, the roughening process may be altogether omitted. This happens when the impressions alone are considered to be adequate for forming an effective liner.

The roughening 730 may be followed by a cleaning process 735 that is shown in the flow chart of FIG. 7 in a dotted box to indicate that this step of the process is optional.

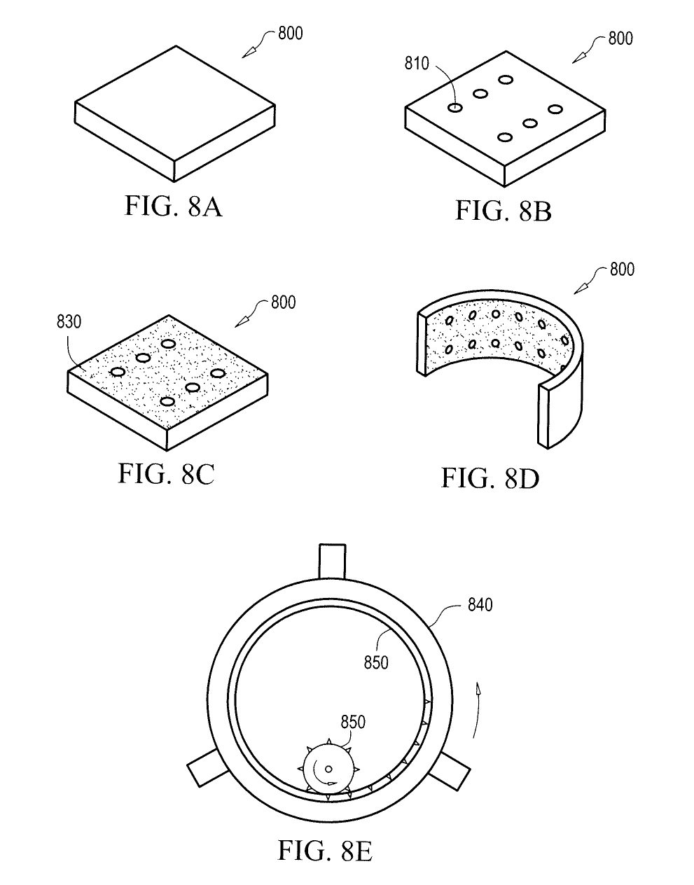

FIGS. 8A, 8B, 8C and 8D show perspective views of a liner 800 being manufactured according to the process of FIG. 7.

In FIG. 8A, a sheet 800 of liner material is shown that has a smooth surface resulting from the original production method. FIG. 8B shows the same liner 800 after impressions 810 have been impressed or formed on the surface of the liner material. FIG. 8C shows the liner 800 after going through a roughening process and developing a rough surface 830. FIG. 8D shows the liner 800 after it has also been rolled into a cylindrical form to fit the interior of a process chamber. The cylindrical form shown is exemplary and the sheet of liner 800 may be deformed into a different shape to conform to the shape of the interior or a portion of the interior of the process chamber.

FIG. 8E shows a side view of a liner being manufactured according a variation of the process of FIG. 7

When the liner material is rolled first and impressions are formed later, a knurling drum may be used as mentioned above. FIG. 8E shows a rolled liner material 800 located inside a chuck 840 and being impressed by a knurling drum 850. The chuck 840 may rotate and the knurling drum 850 may also rotate inside the liner. The patterns and protrusions existing on the knurling drum form impressions into the liner surface.

The liner material may be aluminum including anodized aluminum, stainless steel or another metal, alloy, or composite material that yields to forming impressions by the methods of the embodiments of the present invention. For example, an excessively brittle material, such as ceramic, that is not suitable for punching, pressing, embossing, stamping or drilling may not be suitable for the liner of the embodiments of the present invention.

On the other hand, if a compatible method of forming the impressions is utilized, other types of material may also be used for forming the liner. Other possible materials to be used for formation of the liner include tantalum, tungsten, titanium, aluminum oxide, silicon dioxide, quarts, or austenitic-type steel.

In one aspect of the invention, the liner material is a sheet of aluminum that is 0.007-0.01 inches in thickness and the impressions are 0.001 inch deep. In one embodiment, the liner material is formed from a sheet of material that may be 2 mm to 10 mm in thickness, and the impressions may be 0.1 mm to 2 mm deep and 0.1 mm to 2 mm in diameter or across the impression in plan view.

The average height of the bumps on a surface, measured in micrometers or micro inches, is usually referred to as average roughness (Ra). Grid blasting may be performed to obtain an average roughness of 400-500 Ra and arc spray may be performed to obtain an average roughness of 1000-2000 Ra or more.

Various exemplary embodiments may include very light impressions or very deep impressions, depending on material thickness. The impressions may take almost any shape such as round, square, star or custom. Further, the cross-section of the impression may take a variety of shapes. For example, the impression may have tapered walls or form a semispherical hole.

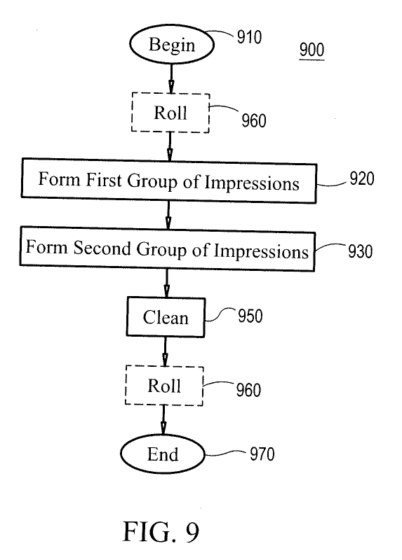

FIG. 9 is a flow chart of a process 900 for manufacturing a liner according to another aspect of the invention.

The process begins in step 910. After the process begins, a first group of impressions are formed 920 on a surface of a material selected for being used as a liner. Next, a second group of impressions are formed 930. Forming the first group of impressions introduces a first stress into the liner material and forming the second group of impressions introduces a second stress into the liner material. The liner material may hence be strengthened by the defect-induced stresses. Then, a surface of the liner material is roughened 940. Then, the liner may be cleaned 950 and washed of excess debris resulting from the formation of the two matrices and the roughening process. The liner material is then rolled 960 to conform to the interior of the process chamber for which the liner is intended. Last, the process ends 970. Alternatively, the roughening may be performed before the formation of one or both groups of impressions.

The two groups of impressions may be formed in a variety of patterns. The formation of the impressions 920, 930 may be conducted as a formation of a first matrix of impressions and a second matrix of impressions. However, alternatively, the first and second groups of impressions may be formed in patterns that are not matrices such as circular, helical, or staggered patterns.

Further, the positioning of the impressions of the second group with respect to the impressions of the first group may assume a variety of arrangements. The second group of impressions may be formed in between the impressions of the first group. In the case of a matrix pattern, the impressions of the second group may be formed along the same rows and columns as the impressions of the first group, or the position of the rows and the columns of the two matrices may be staggered. Alternatively, the second group of impressions may be formed as an appendix or a continuation of the first group of impressions. For example, the impressions of the first group may be formed in one area of the liner surface and the impressions of the second group may be formed in a separate and non-overlapping area.

Shapes of the impressions of the first group and the second group may be the same or different. The impressions of the second group may be such that they modify the shapes of the impressions of the first group. For example, the impressions of the first group may be compressed or expanded as a result of formation of the impressions of the second group.

The formation 920, 930 of the first and second groups of impressions may be achieved by a variety of methods such as stamping, pressing, punching, or embossing. Moreover, when the impressions of the first group are formed with one method, the impressions of the second group may be formed with a different but compatible method.

The roughening 940 process of FIG. 9 may be done through a variety of methods such as those set forth in the description of FIG. 7.

The liner may be cleaned 950 by using a chemical cleaning process. De-ionized water and ultrasonic energy may be used for cleaning 950 the liner.

In an alternative aspect, the roughening of the surface may take place after the one or both sets of impressions have been formed. In yet another alternative aspect, the roughening process may be altogether omitted. The cleaning or washing may also be omitted from the process of FIG. 7.

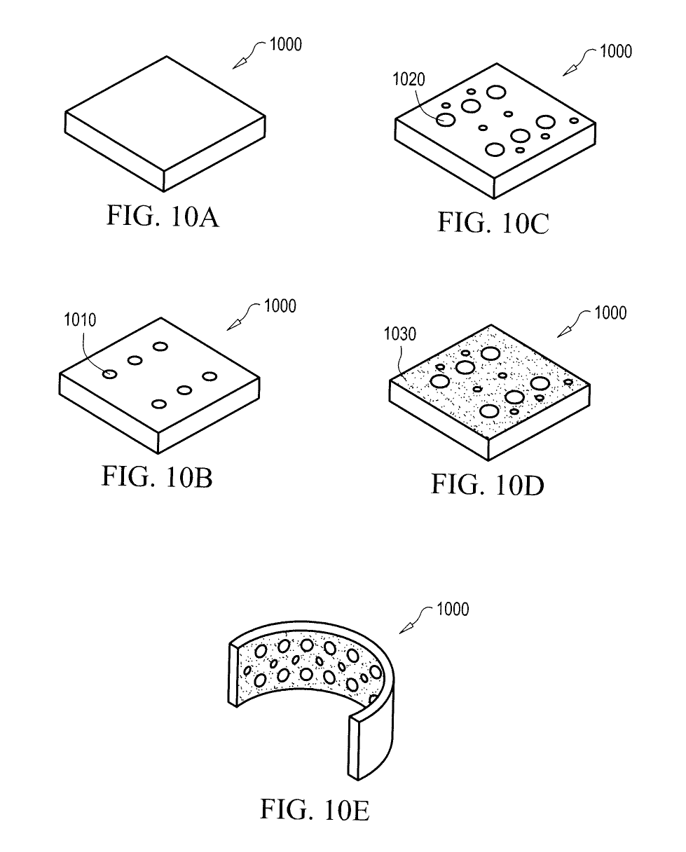

FIGS. 10A, 10B, 10C, 10D and 10E show perspective views of a liner 1000 being manufactured according to the process of FIG. 9.

FIG. 10A shows a sheet of material that is used to form the liner 1000. A surface of this material is likely to have the substantially smooth finish resulting from the process of manufacturing the material. Depending on the process of manufacturing the sheet of material, the surface finish of the material varies.

FIG. 10B shows the liner 1000 after a first group of impressions 1010 has been formed on the surface of the liner. The first group may include holes being punched on the surface such that they create a depression or a hole on the surface that do not penetrates the liner material all the way from one surface to the opposite surface. In the exemplary embodiment shown, the first group of impressions form a matrix of holes.

FIG. 10C shows a plan view of the liner 1000 after a second group of impressions 1020 has been formed on the surface. The second group of impressions is formed as a second matrix. Further, the impressions 1020 of this second formed matrix fall in between the impressions 1010 of the first formed matrix.

FIG. 10D shows the same sheet of liner material 1000 after having gone through a roughening process. The surface of the liner material displays a texture 1030 and a roughness resulting from the roughening or texturizing process.

FIG. 10E shows the liner 1000 after having been rolled into a cylindrical form to fit the interior of the process chamber. The liner may be shaped in a variety of shapes to conform to the shape of the process chamber.

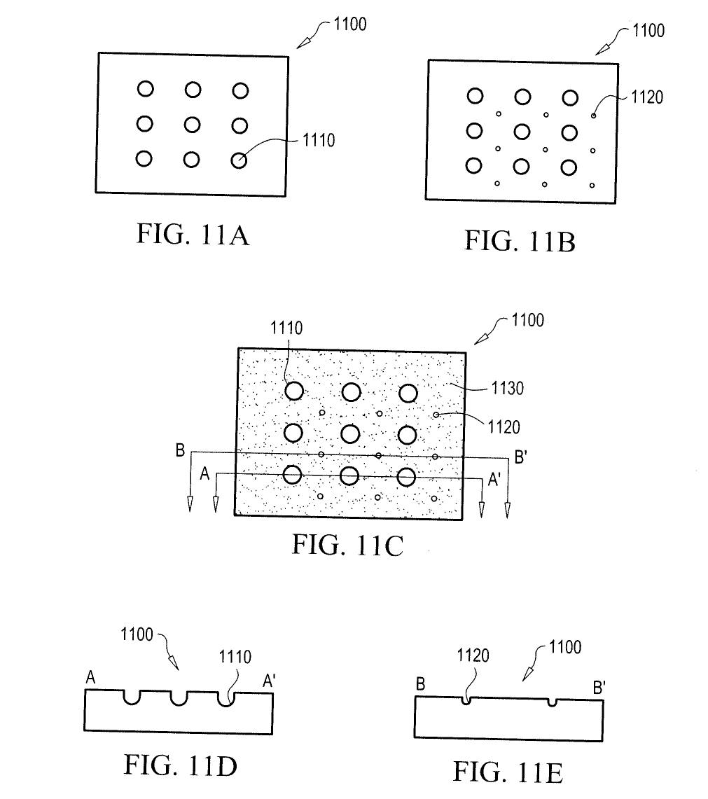

FIGS. 11A, 11B and 11C show plan views of a liner 1100 according to one exemplary aspect of the invention showing formation of the liner according to the process of FIG. 7 or 9. FIGS. 11D and 11E show cross-sectional views of the liner 1100 of FIG. 11C along two different cross-sections.

FIG. 11A shows a group of impressions 1110 having a circular cross-section in the plan view. The impressions 1110 are formed in a matrix pattern. This figure may correspond to a plan view of FIG. 10B and impressions 1110 may correspond to impression 1010 of FIG. 10B. They may alternatively correspond to impressions 810 of FIG. 8.

FIG. 11B shows the liner 1100 after a second group of impressions 1120 have been formed on the liner. The impressions 1120 also have circular cross-sections and are also formed in a matrix pattern. The impressions 1120 are formed between the impressions 1110 that were formed as a part of the first matrix. The impressions 1120 are of a size that is sufficiently small not to impact the size of the first formed impressions 1110. This figure may correspond to a plan view of FIG. 10C and impressions 1120 may correspond to impression 1020 of FIG. 10C.

FIG. 11C shows the liner 1100 after having been texturized and roughened on the surface. This figure may correspond to a plan view of FIG. 10D.

FIGS. 11D and 11E show cross-sections in a direction perpendicular to the plan view and taken across lines AA′ and BB′ of FIG. 11C, respectively. Both of the impressions 1110 and 1120 are shown to have semicircular cross-sections in the vertical which, together with the circular plan view, translate into hemispherical impressions.

The impressions 1110 of the first formed matrix of impressions are shown as a having a circular cross-section in the plan view. Alternatively, impressions of a variety of other shapes may be formed on the surface of the liner 1100. The impressions 1020 of the second formed matrix of impressions are also shown as having circular cross sections in the plan view. A variety of other shapes may be used for the impressions of the second matrix as well. Further, while not shown in the example of FIG. 11C, the impressions 1120 of the second matrix may be such that they deform the circular shape of the impressions 1110 of the first matrix. As such, the first formed impressions 1110 that are shown to be circular in FIG. 11C, may be narrowed by being squeezed between two later formed impressions 1120. This squeezing also impacts the hole along the vertical cross-section.

Deformations of the shape of the first group of impressions by formation of the second group of impressions is further illustrated below.

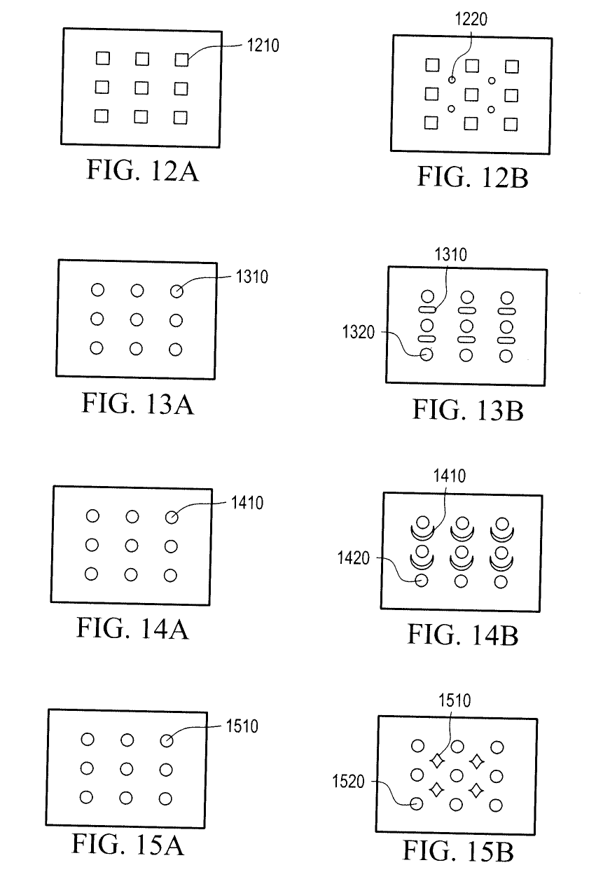

FIGS. 12A and 12B show plan views of a liner according to another aspect of the invention. The first formed holes 1210 have rectangular cross-sections in the plan view and the second formed holes 1220 have circular cross-sections in the plan view. In this example, the second formed holes are sufficiently small not to impact the shape of the first formed holes.

FIGS. 13A and 13B show plan views of a liner according to yet another aspect of the invention. The first formed holes 1310 are formed with circular cross-sections in the plan view as shown in FIG. 13A. However, as shown in FIG. 13B, the formation of the second formed holes 1320 squeezes the first formed holes 1310 into elongated shapes such as a triangular shape with rounded corners.

FIGS. 14A and 14B show plan views of a liner according to yet another aspect of the invention. The first formed holes 1410 are formed with circular cross-sections in the plan view as shown in FIG. 14A. However, as shown in FIG. 14B, the formation of the second formed holes 1420 squeezes the first formed holes 1410 into elongated shapes such as a half-moon shape.

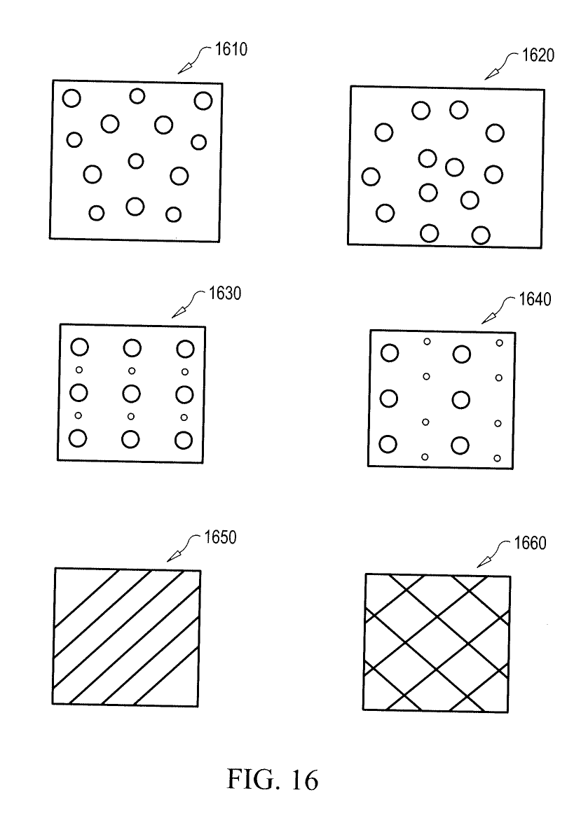

FIGS. 15A and 15B show plan views of a liner according to a further aspect of the invention. The first formed holes 1510 are formed with circular cross-sections in the plan view as shown in FIG. 15A. However, as shown in FIG. 15B, the formation of the second formed holes 1520 squeezes the first formed holes 1510 on four different sides into a modified circle such as a star shape. In FIG. 15B, the sides of the originally circular holes 1510 are pushed inside toward the circle center by the walls of the later formed circular holes 1520.

The dual shapes shown in FIGS. 12A, 12B, 13A, 13B, 14A, 14B, 15A and 15B. may be formed in one step by using a machine that forms the two shapes in one step. Alternatively, the two shapes may be formed in two separate steps of forming a first set of impressions, followed by forming a second set of circular shaped impressions that do not impact the shape of the first set. In another alternative, the liner may be formed by forming a first set of impressions that are subsequently deformed by forming the second set of impressions.

Further the shapes shown in the above figures are merely exemplary and indicative of equivalent embodiments.

FIG. 16 shows several exemplary patterns of formation of the holes or impressions in plan view. In a first exemplary pattern 1610, the impressions or holes are formed along one or more concentric circles. In a second exemplary pattern 1620, the impressions or holes are formed along one or more helical paths. In a third exemplary pattern 1630, the holes are formed along rows and columns. In a fourth exemplary pattern 1640, the holes are formed along staggered rows and columns. In a fifth exemplary pattern 1650, the impressions are formed as parallel grooves or stripes. In a sixth exemplary pattern 1660, the impressions are formed as criss-crossed grooves or stripes. Patterns 1650 and 1660 may be formed by a knurling drum.

The holes or impressions shown in various exemplary patterns of FIG. 16, may be formed in a variety of different shapes and cross-sections, some of which are shown below.

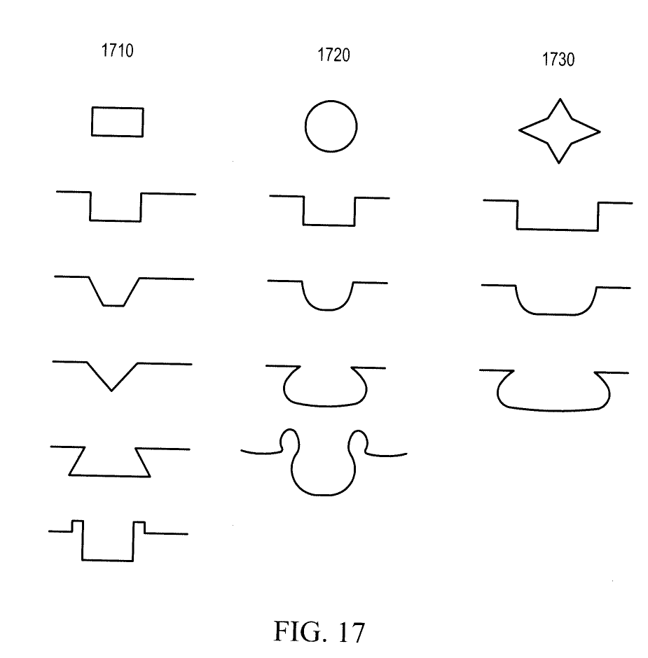

FIG. 17 shows several exemplary cross-sectional views of the holes or impressions in a direction perpendicular to the plan view. Three exemplary plan views are shown each with examples of corresponding cross-section in the direction perpendicular to the plan view (or the vertical cross-section for simplicity). A rectangular 1710, a circular 1720 and a star-shaped 1730 plan view are shown.

The rectangular plan view 1710 may correspond to a rectangular vertical cross-section with straight walls or with tapered walls. The walls may taper inward or outward and may form a pyramid. The material forced out of the impressions may protrude on the sides of the impression forming protuberances. The exemplary cross-sectional views shown as corresponding to the rectangular plan view 1710, may also correspond to the striped or criss-crossed patterns 1650, 1660 shown in FIG. 6.

The circular plan view 1720 may correspond to a cylindrical shape having a rectangular vertical cross-section, a hemispherical shape having a circular vertical cross-section, or another curved shape. The exemplary cross-sectional views shown as corresponding to the circular plan view 1720, may also correspond to the striped or criss-crossed patterns 1650, 1660 shown in FIG. 6.

The start-shaped plan view 1730 may have a variety of rectangular or curved vertical cross-sections.

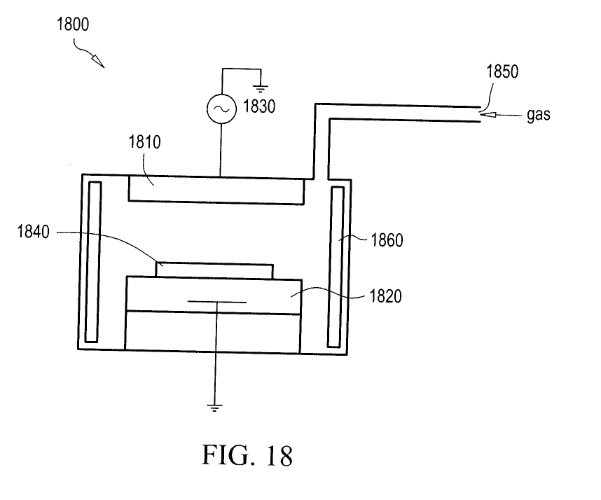

FIG. 18 is a processing chamber including a liner according to an aspect of the invention.

The process chamber 1800 of FIG. 18 includes an upper capacitor plate 1810 that is coupled to a ground voltage, and a lower capacitor plate that is also a chuck 1820 and is coupled to an RF voltage 1830 within the chamber housing. A wafer 1840 may be located on the chuck 1820 and a gas inlet 1850 permits the process gases to enter the housing of the process chamber 1800. A liner 1860 covers the walls of the process chamber. The liner 1860 may also cover the ceiling and the floor of the process chamber 1800.

The liner 1860 used in the process chamber 1800 may be any of the liners described above or any liner formed according to the processes described above in accordance with various aspects of the present invention. The liner 1860 may be removed and discarded to be replaced by a new liner when its efficiency is reduced by accumulation of deposited material. Alternatively, the liner 1860 may be removed and cleaned to be reused.

The process chamber 1800 is exemplary and is used for illustration. The liner of the embodiments of the present invention may be used a variety of process chamber with various degrees of complexity.

The liner of the embodiments of the present invention may be used in various types of deposition chambers such as PVD, CVD, ion metal plasma (IMP), atomic layer deposition (ALD), etch chamber, plasma etch chamber, ion implantation chamber, or in annealing chambers, various types of etch chambers, or other furnace chambers. The chamber may be capacitively coupled or inductively coupled.

It is intended that the above specification and examples be considered as exemplary only, with a scope and spirit of the invention being indicated by the following claims and their equivalents.

What is claimed is:

1. A method for manufacturing a liner for a process chamber, the method comprising:
impressing a surface of a sheet of material with impressions; and
cleaning the sheet of material;
wherein the impressing comprises mechanically altering the surface without removing material.

2. The method of claim 1, further comprising roughening the surface prior to the cleaning.

3. The method of claim 2, wherein the roughening is selected from a group consisting of particulate blasting, plasma spray, and arc spray.

4. The method of claim 1, wherein the cleaning comprises washing the sheet of material with de-ionized water and applying ultrasonic energy.

5. The method of claim 1, wherein the impressing is selected from a group consisting of pressing, punching, dimpling, knurling, or embossing the first surface.

6. The method of claim 1, further comprising
drilling holes in the surface.

7. The method of claim 1, further comprising:
forming the sheet of material to conform to the process chamber after the roughening.

8. The method of claim 1, further comprising:
forming the sheet of material to conform to the process chamber before the impressing.

9. The method of claim 8, wherein the impressing comprises
rotating the formed sheet of material and
pressing against the surface with a knurling drum.

10. The method of claim 9, wherein the pressing against the surface with a knurling drum comprises rotating the knurling drum against the surface.

11. A liner for use in process chambers, the liner comprising:
a sheet of material having a surface being exposed to gases in the process chamber,
wherein the surface comprises impressions being formed mechanically and without removing material from the first surface.

12. The liner of claim 11, wherein the impressions are selected from a group consisting of depressions, protuberances, or a combination of depressions and protuberances.

13. The liner of claim 11, Wherein the impressions have a cross-section in plan view selected from the group consisting of circular, rectangular, star-shaped, parallel grooves and criss-crossed grooves.

14. The liner of claim 11, Wherein the impressions have a shape in a direction perpendicular to the plan view selected from the group consisting of rectangular with straight walls, rectangular with tapered walls, hemispherical, pyramid-shaped, cylindrical, and hole-shaped with protuberances protruding from the first surface around the hole-shaped impression.

15. The liner of claim 11, wherein the impressions are formed in a pattern selected from the group consisting of matrix pattern, staggered superimposed matrices pattern, circular pattern, and helical pattern.

16. A method for manufacturing a liner for a process chamber, the method comprising:
forming a liner having an interior surface;
impressing the interior surface with a plurality of impressions; wherein the impressing comprises mechanically altering the interior surface without removing material from the interior surface.

17. The method of claim 16, further comprising
impressing the interior surface with second set of plurality of impressions.

18. The method of claim 17,
wherein the plurality of impressions comprises a first matrix of depressions,
wherein the second set of plurality of impressions comprises a second matrix of depressions, and
wherein each depression of the second matrix of depressions is formed between respective depressions of the first matrix of depressions.

19. The method of claim 18, further comprising:
spraying particles on the interior surface to introduce roughness; and,
cleaning the sheet of material.

20. The method of claim 16, wherein the impressing is selected from a group consisting of pressing, punching, dimpling, knurling, or embossing the first surface.
